(19) United States
(12) Patent Application Publication
(10) Pub. No.: US 2017/0364952 A1
(43) Pub. Date: Dec. 21, 2017

(54) Global (GPS) Marketing

(71) Applicants: Medhat N. Girgis, Staten Island, NY (US); Alaa A. Shaaban, Stewartsville, NJ (US)

(72) Inventors: Medhat N. Girgis, Staten Island, NY (US); Alaa A. Shaaban, Stewartsville, NJ (US)

(21) Appl. No.: 14/731,261

(22) Filed: Jun. 4, 2015

(51) Int. Cl. G06Q 30/02

(52) U.S. Cl. CPC G06Q 30/0261; G06Q 30/0266; G06Q 30/0271

(57) ABSTRACT

The system and method for targeted and location-based advertisement across several locations. A method for booking and placing an advertisement tor targeted and location-based system includes: registration of a user account in a computer system; a user id and password of said registered user account; graphical representations of various modes of advertisement; uploading and scoring images, audio related to advertisements and media, for easier viewing creating and attaching the desired geographical location detail. The system includes a computer based web application configured to receive data that defines an advertisement from an advertiser; receive, and upload a request to serve an advertisement; and communicate the advertisement to the browser; select geographical location associated by user for advertisement; and configured the geographic location of the advertiser and the geographic location associated for advertisement.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

### (1) Field of the Invention

The present invention generally relates to a system and methods for targeted location-based advertising. More specifically, the present invention relates to a method and process for registration, creation and management of advertisements in different locations.

### (2) Background of Invention

Advertisers are generally willing to pay more to deliver an impression (e.g., a banner ad or other type of advertisement) to users who are especially sensitive to advertisements for their products or are seeking to purchase products corresponding to those sold by the advertisers. The economic model often provides greater compensation in the event of a “click through”, which is a positive action taken by the user to interact with the ad to receive further information. This principle, of course, actually operates correspondingly in traditional media. For example, a bicycle manufacturer in general is willing to pay more per subscriber to place advertisements in a magazine having content directed to bicycle buffs than in a general interest publication.

Advertising is most effective when it is presented to a user for whom it is relevant. For a business with a physical presence, location becomes a very important criterion of relevancy as their target audience is typically formed by the people who are near a retail chain's stores or other location.

Marketers have been able to develop ways to maintain customers once they have initiated purchases via tracking of the consumers purchasing habits and trends. Special loyalty programs have been developed such as reward coupons and other incentives based on the amount, frequency, and trends of the consumer purchases. Other advertisers/on-line retailers such as Amazon.com profile the customers who actually visit their site. With Amazon, the consumer is profiled by the products they view and what they purchase while on the site. Amazon then tracks the consumer's habits of shopping and what they purchased so that when the consumer signs in at another time advertisements will immediately pop up with “suggested items” for the consumer to consider purchasing based on their previous actions and purchases with Amazon only. While these approaches are effective in maintaining already existing customers and motivating the consumer to purchase additional items, they fall short in their ability to secure additional customers from competitors who offer similar products/services. The current advertising methodologies are still unable to track actual consumer spending and trends outside of an already existing customer, i.e. based on a broad spectrum of actual financial transactions within the consumer's financial institution(s).

There are many patents available in the prior art which depicts the various method of advertisement, like U.S. Pat. Application Nos. 20140172573 to The Rubicon Project, Inc. discloses a system and method for advertisers to run multiple advertising campaigns across several locations without having to configure each campaign on a per location basis is provided. The system may determine and assign budgets, target radius, duration, pricing, times of day, etc., for each ad campaign and each location. These settings are not only configured at the time of initial setup, but may also be changed dynamically to adjust for actual results and to account for time-dependent variables. But this method only covers those people having mobile services or internet connectivity.

In addition US 20110179359 A1 discloses the system for serving localized advertisements that defines an advertisement from an advertiser and determines a geographic location of the advertiser. The system also receives a request to serve an advertisement from a browser operated by a user and determines a geographic location associated with the user. The system communicates the advertisement to the browser if the geographic location associated with the user matches the geographic location of the advertiser.

Various other prior art has been found which shows targeted location-based advertising methods such as those found in U.S. Pat. No. 8,121,896 to Paul Lagassey; U.S. Pat. No. 8,818,850 to David Valin, Alex Socolof; U.S. Pat. No. 8,645,209 to Yellowpages.com LLC; U.S. Pat. No. 7,292,559 to Shuichi Yoshino, Masashi Shimizu; U.S. Pat. No. 5,937,392 to Charles D. Alberts; Patent Application No. 20050222908 to Ebbe Altberg; 20110295701 to Justin Phan; 20110208580 to Robert I. Wolinsky; 20130031016 to Jon Shutter; 20130079036 to Hertzel Sharet and PCT Application Nos. 2001063451 to Classified Advertiser Com Inc; 2013043654 to Russel, Robert II Heiser.

However, from above listed prior art it is found that current options for electronic web based advertising are very costly and yield limited results. Also, to reach an acceptable number of consumers to advertise their products/services, advertisers must run campaigns, which reach masses of people, but only yield a single digit return in consumer interest and purchases. For example, out of 100 consumers who see an advertiser's campaign/ad, only 3-5 may be ready, available and willing. Despite their best efforts, current consumer advertising methods remain very costly and yield a minimal return for the amount of investment.

Therefore, there is need of a suitable method or system which provides specifically targeted advertising/ad promotions in a defined geographical region by mean of using various conventional promotional tools/sources like, planes, bus, truck, taxi, panel, etc. Moreover, there is need of a system which directly connects the local vendor of one place to the local customer of different location.

### BRIEF SUMMARY OF THE INVENTION

In the view of the foregoing disadvantages inherent in the known types of system and method for presenting advertisements now present in the prior art, the present invention provides an improved system and method for targeted and location-based advertisement. As such, the general purpose of the present invention, which will be described subsequently in greater detail, is to provide a new and improved system and method for targeted and location-based advertisement which has all the advantages of the prior art and none of the disadvantages.

To address prime objectives, the present invention provides a computer implemented method for presenting advertisements through which a user can register, login and attach an advertisement for his product for a definite geographical location.

Another objective of the system and method for targeted and location-based advertisement of the present invention involves, different sites for advertisement, various modes of advertisement like, a display panel that is readily adapted on bus, truck, taxi, panel etc.,

Another objective of the system and method for targeted and location-based advertisement of the present invention provides dynamic platform services which are cost effective and meet all geographical and logical flexible client interface marketing requirements.

Another objective of the system and method for targeted and location-based advertisement of the present invention is to provide a secure interface for the user which is secure enough to avoid any fraud and misuse of personal data of the user.

A still further aspect of the present invention is to provide a system and method for targeted and location-based advertisement of the general character described wherein specific advertisements are displayed when and where the advertisers choose.

Another feature of the present invention is to provide a mobile display system of targeted and location-based advertisement of the general character described which optimizes exposure of advertising to a target audience at a relatively low cost.

A further consideration of the present invention is to provide a system and method for targeted and location-based advertisement of the general character described which is equally suited for use in a variety of locations from interstate highways to state and county roads as well as urban streets.

Another aspect of the present invention is to provide a system and method for targeted and location-based advertisement of the general character described which utilizes routine travel for purposes other than advertising, thus resulting in reduced costs and conservation of resources.

In this respect, before explaining at least one embodiment of the invention in detail, it is to be understood that the invention is not limited in its application to the details of construction and to the arrangements of the components set forth in the following description or illustratedin the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 shows an illustrative example of a website which provides an interface for targeted and location-based advertisement.

FIG. 2 shows an illustrative example of a web page of FIG. 1 where user can select the desired geographical location for advertisement display.

FIG. 3 shows an illustrative examples of an advertising displays.

FIG. 4 depicts an airplane with internet access.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

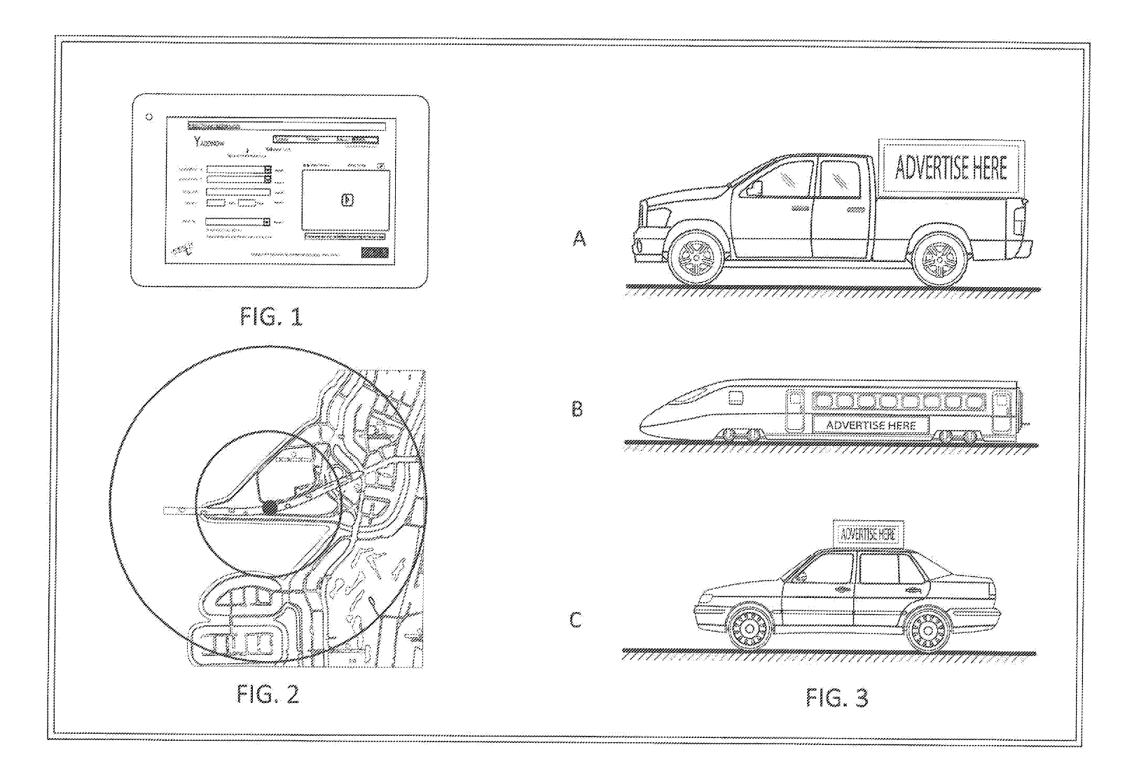

The user interface shown in FIG. 1 has a login option, a banner window and a browser window. The object of the system is to provide a web site that delivers option tor posting advertising content. This website provides an option to incorporate desirable advertisement on any format which is accepted by www, example, JPG, MOV, (any media type file) with sound or without sound which is further modified according to the need of the user.

The preferred program provides a secure system where full registration will take place, which must be secure enough to avoid any fraud and misuse. For Example, all the data of potential users or advertisers, comprises his full information, including company registration, tax ID. After thorough verification, a user ID will be issued to him. After registration a display is open which provides various options in front of the user regarding; sites/locations for the advertisement, mode of advertisement which further displays on planes, bus, truck, taxi, panel etc, on various selected sites/locations.

After the selection of mode of advertisement, location of the user is verified with the data he provided in the first step to avoid any fraud. In a second step the user can select the specific geographical location FIG. 2 where he wishes to show his marketing or advertisement, or select the distance from his location (in number of miles or Kilometers) in radius. After this, page will allow the user to specify the frequency where he wishes to show his material. The time slot of his choice (like, if he wishes to have his material displayed from 18:00-22:00 CET a minute of each hour for the first minute) if available is provided to him and not booked by another user. Once this accomplished, the user can go to the payment page and pay the amount which is displayed over there.

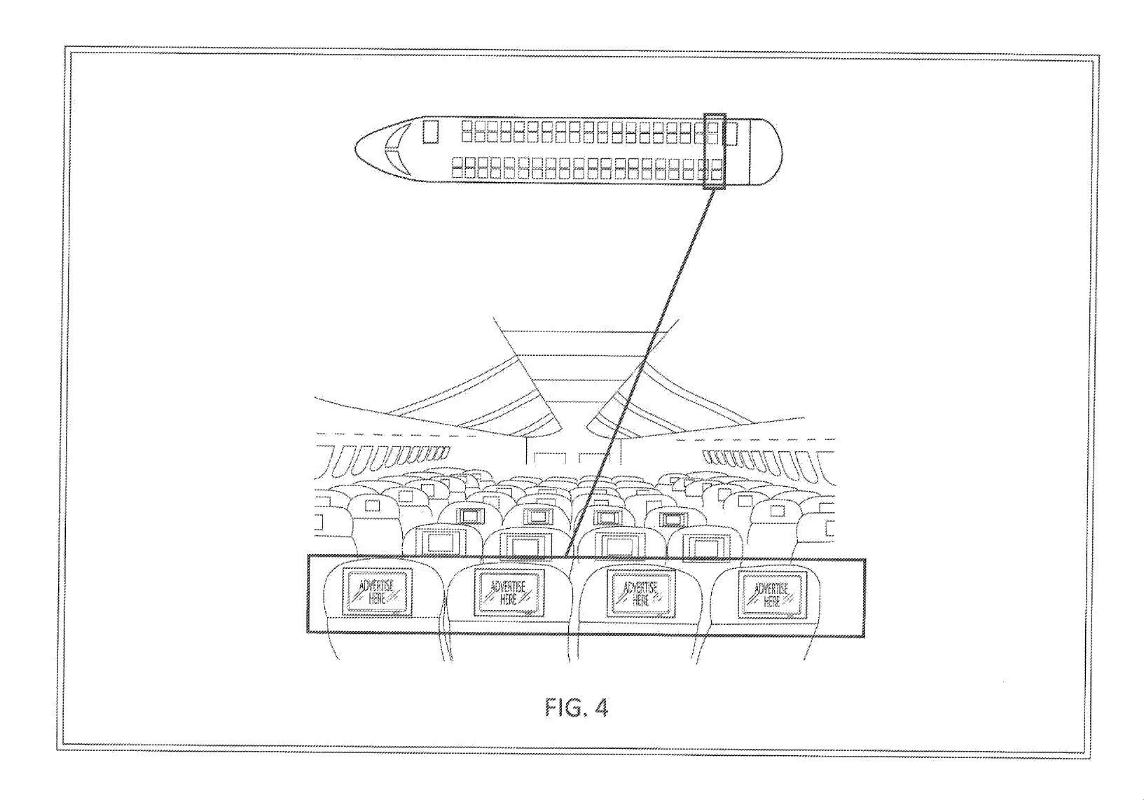

The targeted and location-based advertisement system provides a facility through which users can update their advertising materials from their computer, like a change of menu, a plate of the day for a dinner, or rates for motel rooms, etc. to suit them at a specific moment in time. User will have the ability of dynamic updates. The examples of the advertising displays are shown in FIG. 3. The displays can be placed on a pick up track A, a train B, and on top of a car C. As shown on FIG. 4. Airplanes with internet access can utilize this feature to play ads on screens for each seat.

Advantageously, the present invention provides a unique system and method for targeted and location-based advertisement which is cost effective and meets all geographical and logical flexible client interfaces marketing requirements. This system drives mutual success between supplier and consumer which penetrate global market and reduce time to time budget marketing cost capital cooperate level.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible, it is contemplated that these variations, modifications, additions and improvements fall within the scope of the invention.

We claim:

1. A method for booking and placing an advertisement for targeted and location-based advertisement system comprising:
registering a user account on a computer system;
generating a user ID and password of the said registered user account;
generating, using the computer system, graphical representations of various modes of advertisement;
uploading and storing images, audio, related to advertisements and media, for easier viewing creating and attaching the desired geographical location detail; and
creating and attaching the bank account details for secure payment for desired said selected advertisement for said geographical locations.

2. The method for booking and placing an advertisement for targeted and location-based advertisement system of claim 1, wherein said graphical representations of various modes of advertisement includes a display panel readily adapted on a bus, a truck, a taxi, a panel.

3. The method for booking and placing an advertisement for targeted and location-based advertisement system of claim 1, wherein said geographical location detail further comprises a range in miles.

4. The method for booking and placing an advertisement for targeted and location-based advertisement system of claim 3, wherein said geographical location detail further comprises frequency in second intervals with a minimum of 15 seconds.

5. The method for booking and placing an advertisement for targeted and location-based advertisement system of claim 1, wherein the uploaded format of said advertisement is capturing images, audio, and text.

6. The method for booking and placing an advertisement for targeted and location-based advertisement system of claim 1, wherein the uploaded format of said advertisement is assembling the captured image, audio, and text together or alone accepted by www.

7. The method for booking and placing an advertisement for targeted and location-based advertisement system of claim 1, wherein said secure payment is through credit cards, debit cards, coupons, and vouchers for the purpose of enabling the user to make transactions easy and secure.

8. A system for targeted and location-based advertisement comprising:
receiving data by a computer based web application that defines an advertisement from an advertiser;
receiving and uploading a request to an advertisement server;
communicating the advertisement to the browser;
selecting a geographical location associated by user for advertisement; and
configuring the geographic location of the advertiser and the geographic location associated for advertisement.

9. The system for targeted and location-based advertisement of claim 8, wherein said advertisement server is further configured to communicate advertisements to the browser that match the user preferences.
